(19) United States
(12) Patent Application Publication
(10) Pub. No.: US 2005/0032518 A1
(43) Pub. Date: Feb. 10, 2005

(54) Attribute based communication

(76) Inventor: Nandan Sunder Rajan, Bangalore (IN)

Correspondence Address: FENWICK & WEST LLP, SILICON VALLEY CENTER, 801 CALIFORNIA STREET, MOUNTAIN VIEW, CA, 94041, US

(21) Appl. No.: 10/809,063

(22) Filed: Mar. 24, 2004

Related U.S. Application Data
(60) Provisional application No. 60/457,439, filed on Mar. 26, 2003.

(51) Int. Cl. H04M 3/16; H04Q 7/20

(52) U.S. Cl. 455/435.1; 455/428; 455/445

(57) ABSTRACT

Attribute based communications system include a set of communication units associated with a unique network identifier in a communication network having a switch, a registration center, and a registration database. Users establish user attribute records in the registration database for correlating attributes with network identifier of the user communication unit. Users establish communication links between each other by referencing attributes of the target user rather than the network identifiers of the target user communication unit. The system relates attribute based communication request messages with the registration database to derive the network identifiers for the communication units.

### RELATED APPLICATIONS

This application claims priority under 35 U.S.C. sec 119(e) of U.S. Provisional Application Ser. No. 60/457,439, which is entitled “Attribute Based Communication” and was filed on Mar. 26, 2003 by the same inventor.

### BACKGROUND

1. Field of the Invention

The present invention relates generally to personal communications and more particularly to attribute based communications over existing networks.

2. Description of the Related Art

Consider two strangers across the street from each other with working cell phones. These people can potentially talk to people at the other end of the world, as long as the required network connections are in place (e.g., GSM phones with international dialing). However, they will not be able to talk to each other if they do not know the other person's cell phone number. They may well be able to talk to each other just by calling out to each other in the most primitive form of communication, but under our current social norms, strangers do not typically engage in this conduct.

The more common approach is to use their cell phones. However, current telephone systems require that people wishing to talk to another person know the phone number of the other person.

In some situations, people are able to identify who they wish to communicate with based on some attribute possessed by a person carrying a telephone but we do not know their phone number. For example:
We may wish to alert the people in the car ahead. We can identify the person we wish to speak to as the occupant of the car ahead (identified by its vehicle number). The “vehicle number” is the attribute of the person we use for identification.
We may want to talk to the person sitting in front of us in a restaurant. The person can be identified based on the table she is sitting in. If tables in the restaurant are given some identification, then this table identity can be used as an attribute for identification.
We may wish to speak to the person across the street but we only know their geographic location (e.g., relative location can be an attribute to identify that person).
We may be able to identify the person based on her global positioning system (“GPS”) coordinates. (By specifying a rectangular area in GPS coordinates within which she is located).
We may wish to speak to a person of a certain occupation. Let's say we wish to speak to real estate agents. In this case we are not identifying a specific person but any one person whose occupation is “real estate agent” (attribute—occupation).

In all these cases we have identified whom we wish to speak with based on attributes of the person possessing the telephone, but we are unable to make the conversation because we do not know the telephone number of the other person.

Current communication systems use Intelligent Network architectures such as Signaling System 7 (“SS7”) to provide capabilities such as 800 numbers. Further, Short Message Services (“SMS”) are common in most mobile networks. SMS provides capability to send short data message from one cell phone to another. Other similar messaging systems can also be use, such as, multimedia messaging system (“MMS”), or the like.

Below, we draw attention to aspects of current communication systems to show that components we use in the new system are variations of existing components and hence are implementation using conventional components.

The aspects we are interested are and their usage in our system is discussed below:
1. Ability to initiate a phone call to some virtual phone number, which is not the number to which the call is connected. Communication networks using SS7 is capable of providing capabilities like 800 numbers—where the number dialed itself is virtual and is mapped to some real phone number dynamically when the call is made. We use such virtual phone numbers to initiate attribute calls. The appropriate destination phone number is found dynamically and the call is completed.
2. Ability to receive messages and process them. Mobile networks provide capabilities like SMS. One implementation of SMS is for messages to be sent to a designated number on the network. A component called the Short Message Service Center (“SMSC”) accepts messages destined for this number and then ensures delivery to the intended recipient. (There are differences in implementation of SMS between different systems, but the aspect that we are interested in is not affected by these differences.) We use capability to send data messages to a designated number, quite like SMS—the only difference in this case is that messages are stored in a database accessible to the Signal Connection Point (“SCP”). Also, while SMS requires the message to be routed further to the destination, in our system it is not routed any further.
3. Ability to make an alphanumeric call. In current systems, when a mobile subscriber dials a destination phone number, a call packet is sent to the mobile switching center so that a connection can be set up with the destination phone number.

Therefore, it is desired to provide a method and system that enables communication between persons based on one or more of a set of desired attributes without requiring the specific knowledge of a telephone number associated with the person.

### SUMMARY OF THE INVENTION

In accordance with one illustrative embodiment of the present invention, there is provided a system that allows communications to occur on the basis of attributes rather than phone numbers.

Attributes of people are one of the main drivers of communication. Currently, the requirement to know phone numbers restricts communication. By eliminating the need to know phone numbers an important barrier to communication is removed. Further, the same person can be reached on the basis of multiple attributes—thus providing multiple points on which a person can be reached. Attributes can be registered/removed at the discretion of a person. This provides the ability to be reached on a temporary basis. This is advantageous when talking to strangers—divulging a phone number in such situations can lead to potential loss of privacy. (Listing on marketing lists, etc). The phone number is a permanent identity for communication and temporary identities are helpful in making initial conversation till the need for revealing a permanent identity arises. For example, if you are placing an advertisement for some reason and you need to provide a number for people to call you back you could set up an attribute and ask people to use that to contact you. The attribute can be removed after a designated period (say 2 weeks)-thereby protecting you from having to reveal your phone number.

In one embodiment, a system is provided for people to register any attributes on which they can be contacted and their phone number in a database. (e.g. occupation, vehicle number, or the like). A user wishing to communicate with someone with a particular attribute, or set of attributes, initiates a call request to a designated system phone number. The user specifies the attributes of the intended call recipient. The system processes the call request by receiving the attribute information and searching the database to find a phone number associated with a matching attribute or set of attributes. Then, a telephone communication link is established between the initial caller and the person having the caller's requested characteristics.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a system element and communication flow diagram for an attribute call system according to one embodiment of the present invention.

FIG. 2 is a system element and communication flow diagram for a Bridge attribute call system according to one embodiment of the present invention.

FIG. 3 is a hierarchical Venn diagram of sets of phones relating to a communication group attribute call system according to one embodiment of the present invention.

FIG. 4 is a system element and communication flow diagram for a real-time group networking attribute based communication system according to one embodiment of the present invention.

FIG. 5 is a system element and communication flow diagram for a visual identification based group networking attribute call system according to one embodiment of the present invention.

### DETAILED DESCRIPTION OF THE INVENTION

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Unlike current systems where a sequence of digits is “dialed” to make a call, in our system a sequence of attributes is “dialed.” This is just alphanumeric information that is substituted instead of the digits. It should be noticed that with respect to the present description, the terms “phone numbers” are used without differentiating between numbers used by phone subscribers and numbers used by the communications network in identifying subscribers or routing call requests. This is mainly to facilitate easy explanation.

The details of connectivity between the switching components, hardware-software split, and implementation details of these components are conventional in nature and are within the realm of knowledge of those skilled in the art. Similarly, communication between cell-phone, base station, and mobile switching center takes place in a conventional manner according to any of the existing communication protocols (e.g., Global System for Mobile Communications (“GSM”), Digital Cellular System (“DCS”), Integrated Services Digital Network (“ISDN”), Plain Old Telephone System (“POTS”), or the like). It should be noted that other wireless communications networks could be used to implement a system according to an embodiment of the present invention. Such wireless communications networks operate according to a protocols or standards associated with wireless communications technologies, such as for example, GSM, DCS, Personal Communication Service (“PCS”), Personal Digital Cellular (“PCD”), Global Packet Radio Systems (“GPRS”), Bluetooth, Infrared Data Association (“IrDA”), or the like.

In addition, for ease of description, some terms are described below as they are used with respect to the embodiments described herein. To the extent that these definitions are narrower than the common use of the terms, they are applicable only with respect to these embodiments and are not intended to limit the scope of the claims.

Communication system: all equipment used in establishing a communication link between the communicating parties. This includes broadly the communication devices and communication network; Virtual phone number: a phone number that does not represent any phone, it is just a number that will be used by the communications system to determine the actual phone number that is to be called (e.g. 800 numbers); Attribute: some information about a person. In the communication system, it is represented by a name that identifies the type of information and an associated value that is specific to the individual person (e.g., For someone whose profession is teaching, the “Occupation” attribute has the value teacher. Here the type of information is the nature of work a person does. This is identified by “Occupation” and for this particular person the value is “teacher”); Registration information: attributes and associated phone number; Resolution: usually used to denote the operation of determining a phone number based on a set of specified attributes (e.g., attribute resolution); Name-value pairs: this consists of a name specifying a particular type of information followed by a specific value for that type of information (e.g., Occupation=teacher where occupation is the name and “teacher” is the value.)

In the embodiments described herein, mobile phones or cell phones are suitably modified to perform functions such as sending and receiving the messages defined later. Current mobile phones have the capability to send and receive SMS messages and hence modification to use a new message format is an extension of current capabilities. Further, the network components are conventional and their operation as it relates to passing messages through the network components according to the present invention is similar to the current SMS messaging operations.

The principles used in building systems according to the several embodiments of the present invention can be used for fixed telephones as well as with different mobile telephone systems (GSM, CDMA, and the like). Further, although the explanation uses people as the end parties in a call, the system works any entity that is an end party in a telephone connection. Although the explanations below show voice calls being made, similar SMS based messaging systems as well as Internet Protocol based communication devices can use the same principles—there are many communication channels that can use attribute calls. The current system can be easily adapted to these other channels.

### Illustrative Embodiment using Mobile Phones

These concepts are embodied in a sample embodiment explained below. According to this embodiment, two mobile phone users are exemplary users for description of the system operation.

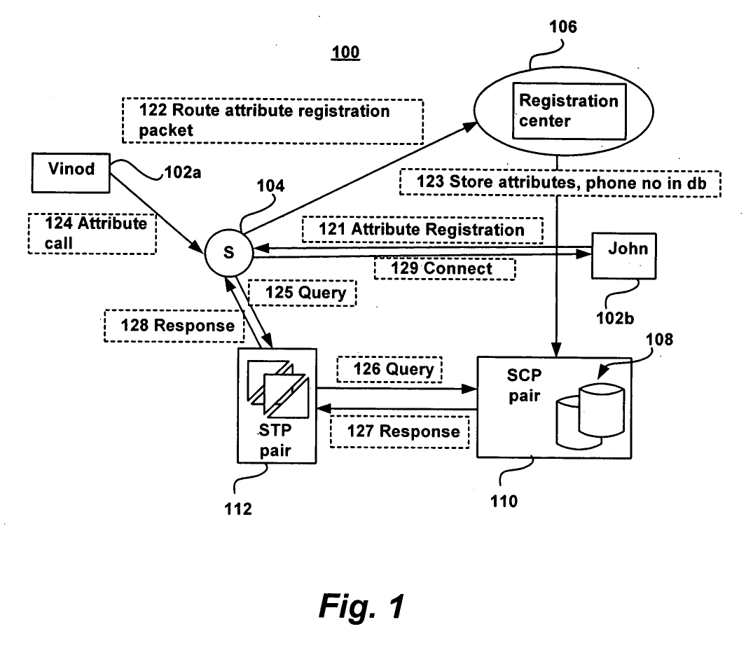

Now referring to FIG. 1, one embodiment of a mobile phone system 100 is shown. User Vinod 102a is able to make an attribute call to user John 102b. User Vinod 102a is a representative user having a mobile phone. In this scenario Vinod 102a wishes to communicate with a paramedic. (i.e., he is identifying the person he wishes to communicate based on “occupation” attribute of the person). Similarly, User John 102b possesses a mobile phone and is a qualified paramedic. He is willing to have people contact him in case they need a paramedic. Any number of attributes can be used according to this embodiment. For example, users of this embodiment are able to send and receive calls based on a user's electronic mail address (“email-id”). This is accomplished by registering a user's email-id as an attribute with the system.

The telecom network switch 104 is a “Signal Switching Point (SSP)” as defined in SS7 terminology. For simplicity in this scenario this switch services the phones of Vinod 102a and John 102b. However, as it is known in the art, different switches may service different users while still performing the same basic communication operation.

Registration Center 106 (“RC”) is similar to the Short Messaging Service center (“SMSC”) used, for example, in Short Message Service of GSM networks. Registration Center 106 answers to a designated phone number on the mobile network, accepts registration messages and stores registration information in a database. The database 108 used by RC 106 is the same as used by Signal Connection Point 110 (SCP).

Signal Connection Point (SCP) pair 110 is a conventional SCP pair as defined with respect to SS7 systems. The SCP pair 110 includes databases 108 that provide information for advanced call processing. In this case, the SCP pair 110 and the RC 106 share the same databases 108. Hence the registration information is available for querying.

The Signal Transfer Point (“STP”) pair 112 is also a conventional STP pair as defined with respect to SS7 systems. The STP pair 112 receives and routes incoming signaling messages towards the proper destination.

According to this embodiment of the present invention, a modified message layout is used for communications between the network components. The general layout of a message includes a protocol identifier field, (“Protocolld”), a message identifier field (“Messageld”), a length of data field (i.e., Length of remaining data), and the Message data. The Length of remaining data field includes a value for the length of the data following this field in the message, for example in kilo bytes (“Kb”). The Message data includes the actual data corresponding to the message (i.e., the payload).

According to this embodiment, two message types are provided. In general, message data is provided in Name-value pairs. For example, a list of name-value pairs is specified by using a ‘;’ as the delimiter of list of elements.

The first message type is the “Attribute_register” message. The Attribute_register message is sent to Registration Center 106 by a user 102 wishing to register attributes. After registration, this user 102 can be contacted by other users 102 on the basis of those attributes. Table 1a shows the general lay out of a message data field for an Attribute_register message. Table 1b is one example of an Attribute_register message according to this embodiment.

TABLE 1a

| | | |
|---|---|---|
| ATTRIBUTE | REGISTER | DATA_LENGTH |

REGISTERED_PHONE_NUMBER=VALUE;
SEMICOLON SEPARATED LIST OF ATTRIBUTES

TABLE 1b

| | | |
|---|---|---|
| ATTRIBUTE | REGISTER | Computed length of remaining data |

REGISTERED_PHONE_NUMBER=7334564444;
OCCUPATION=PARAMEDIC;

The second message type is the “Attribute_resolve” message. The Attribute resolve message is sent to a designated virtual phone number associated with the system 100 by a user 102a who wants to call another user 102b possessing a specific attribute value. Table 2a shows the general lay out of a message data field for an Attribute_resolve message. Table 2b is one example of an Attribute_resolve message according to this embodiment.

TABLE 2a

| | | |
|---|---|---|
| ATTRIBUTE | REGISTER | DATA_LENGTH |

ATTRIBUTE_NAME=VALUE;

TABLE 2b

| | | |
|---|---|---|
| ATTRIBUTE | REGISTER | Computed length of remaining data |

OCCUPATION=PARAMEDIC;

The messages can be handled by the RC 106 and STP pair 112 to store and retrieve attributes and phone numbers according to the present embodiment. The attributes and phone numbers are stored in database 108, which maintains the attribute—phone number correlation information. Database 108 stores this information in an attribute table. The SCP Pair 110 and the RC 106 share this same database 108. The attribute information is stored according to the layout shown in table 3a. One example table entry is shown in Table 3b.

TABLE 3a

| | | |
|---|---|---|
| ATTRIBUTE_NAME | VALUE | REGISTERED_PHONE_NUMBER |

TABLE 3b

| | | REGISTERED_PHONE_{—} |
|---|---|---|
| ATTRIBUTE_NAME | VALUE | NUMBER |
| OCCUPATION | PARAMEDIC | 7334564444 |

### System Operation

For description purposes, a set of sample phone numbers are used to describe the operation of the system according to one embodiment of the present invention. As a general matter, the area code “600” used in connection with this description is intended to represent a conventional virtual number prefix, e.g., 800, 877, or the like. Elements of the system 100 are associated with phone numbers as follows:
Registration phone number: 600-555-7777
Attribute call number: 600-111-2222

User John's phone number: 733-456-4444

Table 4 describes one embodiment of system 100 as shown in FIG. 1.

TABLE 4

| Step | Description | Example |
|---|---|---|
| 121 | Attribute registration: | John wants people to reach him based on his |
| | A registration message | occupation. So he creates a “Attribute_register” |
| | (Attribute_register) containing | message (similar to a SMS message) and sends it |
| | attributes and phone number is | to the registration number 600-555-7777 |
| | sent to a designated registration | This message specifies John's occupation |
| | phone number | attribute, phone number. (REGISTERED_{—} |
| | | PHONE_NUMBER=7334564444; |
| | | OCCUPATION=paramedic;). |
| 122 | The call is routed through the | John's call is routed through the switch to the |
| | switch 104 to the registration | registration phone number |
| | phone number | |
| 123 | Registration center 106 stores | John's attribute information and phone number |
| | details in database 108. | are stored. |
| | | In Attribute table: |
| | | ATTRIBUTE_NAME=OCCUPATION, |
| | | VALUE=paramedic, |
| | | REGISTERED_PHONE_NUMBER=7334564444 |
| 124 | Attribute call | Vinod is on the highway and needs a paramedic to |
| | Caller 102a sends a data packet | assist him. He makes an attribute call to 600-111- |
| | specifying attributes and desired | 2222 specifying the attribute he is looking for |
| | values to a designated virtual | (OCCUPATION=paramedic). |
| | phone number | |
| 125 | The switch 104 realizes it | Switch S realizes it cannot complete a 600 series |
| | cannot complete the call and | number and so sends a query to STP with attribute |
| | sends a query to STP 112 | information specified in the call and the virtual |
| | | phone number (600-111-2222). |
| 126 | STP 112 sends the query to SCP | |
| | 110 | |
| 127 | SCP 110 uses the passed | SCP uses the passed attribute information to look |
| | information to query stored | for a record that matches. It retrieves John's |
| | records and retrieves associated | phone number since his attribute matches the one |
| | phone number is then passed | specified in the query. |
| | back in a response to STP 112 | In terms of the database the query is looking for |
| | | records matching the following criteria: |
| | | (ATTRIBUTE_NAME=OCCUPATION, |
| | | VALUE=paramedic) |
| | | It returns John's phone number to STP. |
| 128 | STP 112 sends response back to | |
| | switch 104 | |
| 129 | Switch 104 now completes call | Switch knows John's phone number is handled |
| | with phone of user 102b | by it and so completes the connection with John's |
| | | phone. |

### Illustrative Embodiment of Bridged Call System

Disclosing a phone number can result in a loss of privacy. There are situations where both parties do not want to reveal their phone number—for example during a one-off trade. There may be no need for further communication if the trade does not go through.

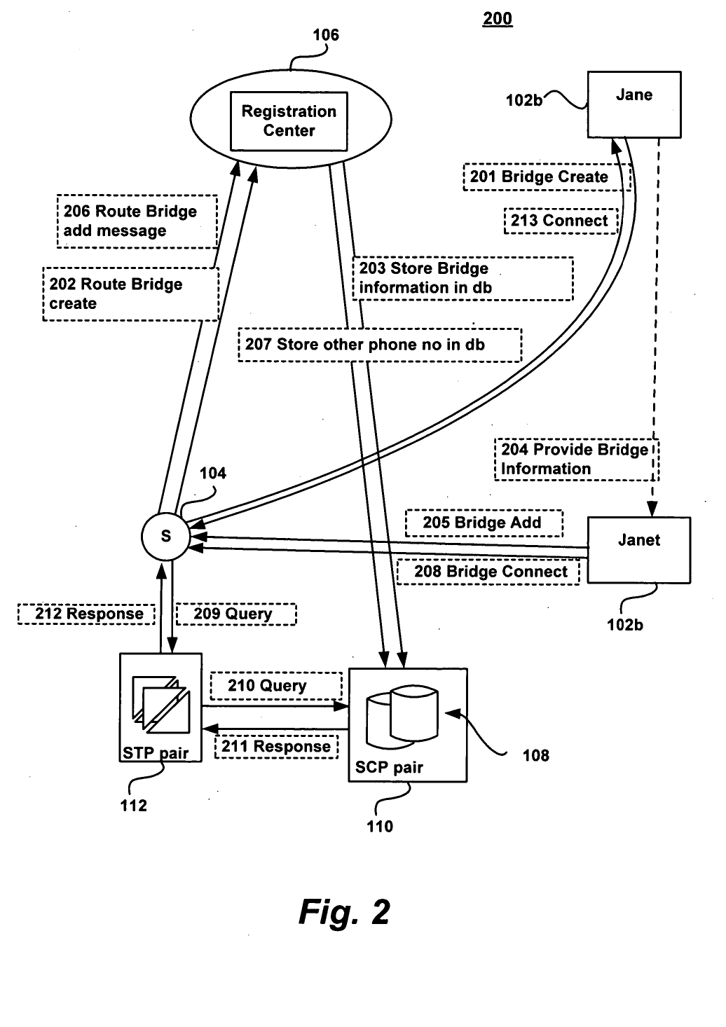

According to one embodiment, this is can be accomplished by creating a “bridge” between the users. Now referring to FIG. 2, one embodiment of a Bridge Call System 200 is shown. A bridge is an entity that creates a communication link between phones. The communication network provider maintains the bridge. A database with a bridge identifier along with associated phone numbers is maintained. Whenever a call is made to a designated virtual phone number and the bridge identifier is specified a connection is established between the phone numbers associated with the bridge. The network provider hides the phone numbers of one participant from the other. The people involved in the call need to just know about the bridge identifier.

According to this embodiment, several message types are provided. In general, message data is provided in Name-value pairs. For example, a list of name-value pairs is specified by using a ‘;’ as the delimiter of list of elements.

The first message type is the “Bridge_Create” message. The Bridge_Create message is sent to Registration Center 106 by a user 102 wishing to maintain a phone number anonymity in the system 200. The Bridge Create message includes three fields, a user phone number field (“OWNER_PHONE_NUMBER”) to identify the phone number that is to remain anonymous, a user defined name to identify the bridge (“BRIDGE_NHAME”), and an optional password (“PASSWORD”) so that only the user can make changes and access the phone number information. Table 5a shows the general lay out of a message data field for a Bridge_Create message.

Similarly, Tables 5b-5d show the fields for other message types according to this embodiment: Bridge_add for connecting another user's phone (“OTHER_PHONE_NUMBER”) to an existing bridge, Bridge_connect for establishing a call, and Brige_delete to remove the other user's phone number from the associated bridge related to a particular user.

TABLE 5a

| | | |
|---|---|---|
| BRIDGE | CREATE | DATA_LENGTH |

OWNER_PHONE_NUMBER=VALUE;
BRIDGE_NAME=VALUE; PASSWORD=VALUE;

TABLE 5b

| | | |
|---|---|---|
| BRIDGE | ADD | DATA_LENGTH |

OTHER_PHONE_NUMBER=VALUE;
BRIDGE_NAME=VALUE; PASSWORD=VALUE;

TABLE 5c

| | | |
|---|---|---|
| BRIDGE | ADD | DATA_LENGTH |

BRIDGE_NAME=VALUE; PASSWORD=VALUE

TABLE 5d

| | | |
|---|---|---|
| BRIDGE | DELETE | DATA_LENGTH |

OTHER_PHONE_NUMBER=VALUE;
BRIDGE_NAME=VALUE; PASSWORD=VALUE;

The messages can be handled by the RC 106 and STP pair 112 to set-up a bridge and store and retrieve phone numbers associated with a bridge according to the present embodiment. The bridge information and phone numbers are stored in database 108, which maintains the attribute—phone number correlation information. Database 108 stores this information in a bridge table. The SCP Pair 110 and the RC 106 share this same database 108. The bridge information is stored according to the layout shown in table 6.

TABLE 6

| | | | |
|---|---|---|---|
| BRIDGE_NAME | PASSWORD | OWNER_PHONE_NUMBER | OTHER_PHONE_NUMBER |

### System Operation

For description purposes, a set of sample phone numbers are used to describe the operation of the system according to one embodiment of the present invention. As a general matter, the area code “600” used in connection with this description is intended to represent a conventional virtual number prefix, e.g., 800, 877, or the like. Elements of the system 100 are associated with phone numbers as follows:

| | |
|---|---|
| Bridge connection phone number | 600-565-6556 |
| Registration center phone number | 600-444-6666 |
| Jane's phone number | 733-555-4444 |
| Janet's phone number | 733-444-5555 |

Table 7 describes one embodiment of system 200 as shown in FIG. 2. For illustration purposes, corresponding examples to each of the steps relate to a sample transaction. In this example, Jane and Janet are users negotiating the sale of a cupboard. As they do not know each other they prefer to use a Bridge for this one-off communication.

TABLE 7

| Step | Description | Example |
|---|---|---|
| 211 | Bridge creation: | Jane sends a Bridge_Create message to the |
| | Someone 102a who wants a bridge | registration center. |
| | created sends a Bridge_Create | The parameters are: |
| | message. | OWNER_PHONE_NUMBER=7335554444; |
| | | BRIDGE_NAME=sofa_sale; |
| | | PASSWORD=4567; |
| 212 | Switch 104 routes call to | |
| | Registration Center 106 | |
| 213 | Bridge is created: Bridge name, | At the registration center the information is |
| | password, owner phone number is | stored in the database. |
| | stored in database 108 | |
| 214 | Bridge information is passed on to | Jane sends Janet an email with Bridge |
| | other person 102b | information. (Name and password) |
| 215 | Other person 102b sends a | Janet sends a Bridge_add message to the |
| | Bridge_add message | registration center with her phone number, |
| | | bridge name and password. |
| | | The parameters are: |
| | | OTHER_PHONE_NUMBER=7334445555; |
| | | BRIDGE_NAME=cupboard_sale; |
| | | PASSWORD=4567; |
| 216 | Switch 104 routes call to | |
| | registration center 106 | |
| 217 | Bridge name and password is | At the registration center the bridge name |
| | validated at the Registration center | and password is validated and then Janet's |
| | 106 and the other person's phone | phone number is updated in the database. |
| | number is recorded | |
| 218 | Any of the two persons now sends | Janet sends a “Bridge_Connect” message to |
| | a “Bridge_Connect” message to a | the bridge connection phone number. |
| | designated virtual phone number. | |
| 219 | The switch 104 realizes it cannot | Switch S realizes it cannot complete a 600 |
| | complete the call and sends a | series number and so sends a query to STP |
| | query to STP 112. | with bridge information and caller phone |
| | | number. |
| 220 | STP 112 sends the query to SCP | |
| | 110. | |
| 221 | SCP 110 uses the passed | SCP uses bridge name and password to |
| | information to query stored | retrieve correct record. It then uses caller |
| | records. Since the caller phone | phone number to identify the other phone |
| | number is known, it determines the | number to which call should be completed. |
| | other phone number associated | Since Janet made the call it returns Jane's |
| | with the bridge and this phone | phone number to STP. |
| | number is returned back to STP | |
| | 112. | |
| 222 | STP 112 sends response back to | |
| | switch 104. | |
| 223 | Switch 104 completes call with the | Switch realizes Jane's phone number is |
| | other user 102 | serviced by it and hence completes the call. |

### Illustrative Embodiment of Real-Time Networking

As we go through our daily routine we come across hundreds of people around us: in supermarkets, restaurants, traffic intersections, theatres, etc. If we knew more about them, we may realize they possess attributes that may be of use to us and hence we may wish to communicate with them. Suppose we wish to speak with someone possessing a certain attribute. (Let's say real estate agents) We may be interested in speaking to someone who is in our vicinity at this very moment so that we can potentially meet conveniently at short notice. This would avoid us having to go out of our way to meet them. As we look for real-estate agents—perhaps they are sitting at the restaurant next door. If we could know they were real estate agents and if we could discretely talk to them with our phone, we could evaluate and then potentially meet with minimal inconvenience since they are close to us. Additionally we may want to talk to people around us just because of some attribute they possess—perhaps they like gardening and you could potentially find common ground later.

Accordingly, one embodiment of the present invention provides a system of communication where cell phone users who do not know each others phone numbers can join an electronic communication group, identify people in the group who possess a desired attribute and then interact with the other person without any loss of privacy such as disclosure of phone number. The communication channel can be established on a one-off basis with no after effects such as the nuisance of the other person continuing to contact you despite your disinclination to continue to communicate. For example customers at a shopping mall can join an electronic communication group, discover people with some attribute that they find useful and then interact. In a sense, the system greatly enhances your chances of ‘bumping into’ someone who you could find useful in some way.

### A Hypothetical Example

A hypothetical restaurant decides to facilitate its customers to discover attributes about each other, interact and potentially benefit from the interaction. The management of the restaurant decides to manage an electronic communication group (“restaurant group”). They specify a group administration policy that restricts registration and resolution of attributes in its group to only customers present in the restaurant.

Customers to the restaurant are potentially strangers to each other. They may possess attributes that may be of potential benefit to others. By registering their attributes in the restaurant group they are providing an opportunity for other customers to discover their skills and potentially utilize them. The un-coordinated presence to two strangers in the same restaurant could potentially turn beneficial for them when they discover some desired attribute that the other person possess. In the absence of this system, this opportunity would have been lost due to the lack of a mechanism to discover such attributes.

The benefit of this system is that when you search based on attributes within the restaurant group you are assured that the person you are talking to is around nearby (in the restaurant) and you can easily meet up. (The group administrator maintains the information in the group to some degree of accuracy). Further, you may be able to draw some inferences about the person based on the image of the restaurant. (e.g. If this is an up market restaurant you may think it more likely that the person is reasonably successful.)

Now let's go back to our original problem of locating real estate agents who are “nearby”. Let's say we are right now in a restaurant located in a shopping mall. Let's say we have different groups—one for users anywhere in the city, the second for people in the shopping mall and the third for people in the restaurant. Then we can search for people with the attribute desired by us in any of these groups, based on our discretion. We may look in our nearest group- the restaurant we are in, before trying the shopping mall and then potentially the city group.

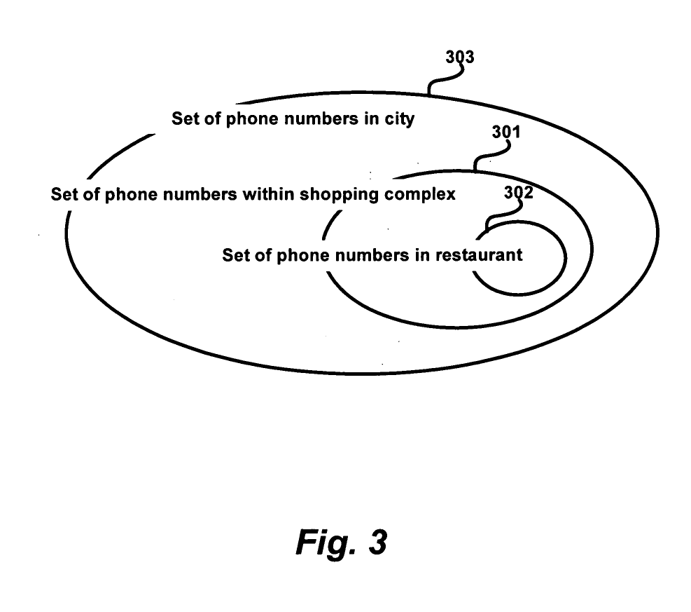

As can be seen in FIG. 3, the shopping mall group 301 can potentially have more phones registered with it than the restaurant group 302. However the people in the city group 303 are spread across the city and it may be inconvenient to meet them. Thus, when trying to locate someone with a specific attribute various groups can be attempted based on the caller's discretion.

### Illustrative Embodiment of Real-Time Networking in a Group

The working of such a system is explained with reference to FIG. 1. As described with respect to FIG. 1, all attribute information was stored in a database 108 without any grouping. However, according to this embodiment, by associating a group identifier with the attribute information groups can be implemented. This is explained in more detail below.

For example, a virtual phone number is assigned to denote the group representing the restaurant. This phone number is used as the group identifier that will uniquely identify all information pertaining to the group. The restaurant management is made to identify one phone number that will act as the group administration phone number. These phone numbers are recorded in a database 108. Only the group administration phone number will be allowed to send registration messages for the group. As customers come in, registration messages are sent on behalf of the customer to the designated registration number from the group administration phone number. The registration information is stored along with the group identification information—thereby tying the registration information to the group. When customers need to make attribute calls within the group, they send an attribute resolve message—but as opposed to the system virtual number, this time a user dials the virtual phone number designated for the group. The call is routed to the SCP 110. According to this embodiment, the SCP 110 searches for suitable attributes belonging to the specified group (identified by the group identifier in the database 108) and thus resolves the call only within registration made in the group.

One example of a common situation that can be greatly improved with a group system according to this embodiment is an airline flight. In general, airlines recognize that flights, particularly long flights, can be boring. In order to attract and maintain customers, airlines provide several entertainment systems, e.g., in-flight movies, audio channels, and the like. Another in-flight entertainment may include an attribute based communication system that can be used by passengers to communicate with each other. For example, a number of topic groups can be created on board based on attributes registered by different passengers. Passengers can then communicate based on their interests, when they wish to and without any loss of privacy.

According to the group feature of the present invention, groups can generally include two types based on registration type, that is, controlled or unrestricted registration.

Controlled Registration Without Disclosure of Phone Number to Administrator

One aspect of the system that can be a powerful driver for communication between strangers is the ability to communicate without having to disclose any information (e.g. phone numbers) that can be a source of nuisance later. The group system described above necessitates disclosure of phone numbers to group administrators. This can potentially be an inhibiter in using the system. Group administrators need to have capability to control attribute registration/deletion to the group. However, people may not be comfortable providing their telephone numbers to administrators. To solve this problem a ‘port’ mechanism is used. A port is a name-password pair that provides permission for registering and resolving attributes within a group. Group administrators create ports and pass on this information to potential members. These members then use port information to register and resolve attributes. According to this embodiment, registration and resolution messages are validated for port information and hence only those with valid port information can participate in the group.

As can be seen from the above description, the usage of the port mechanism allows administrators to control information in the group without knowing about the phone numbers of the people involved.

There are many ways to implement these concepts. In one embodiment groups are implemented as a service of the communication network provider. That is to say that the communication network providers provide a ‘site grouping’ service. The service provides the capability to create groups and manage them. The actual management of the group is left to whomever avails of this service (i.e. the customer). Thus the group information is maintained in databases of the network provider with management control resting with whoever is running the group. Customers who would be interested in managing a group would be management of restaurants, theatres, shopping malls, and the like.

In general, a group enabled system according to this embodiment includes the following procedures:
(1) Group creation: When a customer requests for a group to be created, a suitable software application is used to reserve a virtual phone number to represent the group. This number is called the group phone number (“GROUP_PHONE_NUMBER”). The customer is made to designate someone as a group administrator and that person's phone number is designated the group administrator number. The group phone number and group administrator phone number are recorded in a database of the network provider.
(2) Port creation: The group administrator sends a message to a registration center (as before), specifying port creation information. The message is validated to be from the group administrator and the port name, password and group identifier is recorded in a database.
(3) Group Membership: The group administrator provides the port information to anyone she permits to join the group. This can happen in any manner on a written piece of paper, orally, or the like. Anyone who has valid port information is a member of the group.
(4) Attribute registration: The new group member sends an attribute registration message to the registration center. The message also contains the group identification so that the destination group is known. At the message center, a suitable application uses the information in the message to validate that the port name and password is valid for the group. The attribute information is then stored in the database.
(5) Attribute resolution: A group member creates an attribute resolution message and sends it to the group phone number. This message has the port name, password along with the attribute information. Since the group phone number is a virtual phone number, the call is routed to the SCP. At the SCP the port information is validated and the group information in the database is queried for a matching attribute.
(6) Call Set-up: When a record with matching attribute is found, the call is completed with the associated phone number.
(7) Port Reuse: When the group administrator deems that a persons membership has expired, the administrator sends a “port free” message to the registration center. On receipt of this message membership is deleted for the person using the port. This is accomplished by deleting registration information of the person.

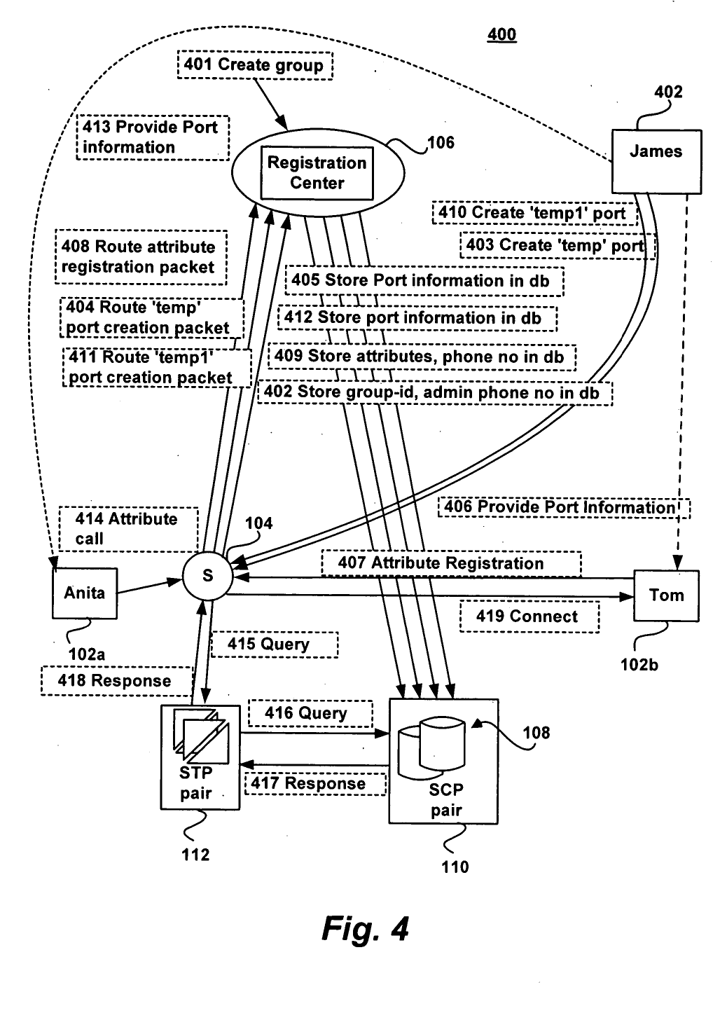

Now referring to FIG. 4, a sample controlled registration group enabled embodiment of a system 400 is shown. For illustration purposes, the system is described with respect to a sample transaction wherein a user 102a “Anita” makes a call to another user 102b “Tom.”

The system 400 includes communication network elements described with respect to FIG. 1. Same reference numerals are provided for similar elements and for their description see above. Additionally, system 400 includes a group administrator 402, depicted as “James.”

According to this embodiment, several message types are provided. In general, message data is provided in Name-value pairs. For example, a list of name-value pairs is specified by using a ‘;’ as the delimiter of list of elements.

The first message type is the “Port_Create” message. The Port_Create message is sent to Registration Center 106 by a group administrator to create a group port. A group member can then use the port to register and resolve attributes. The Port_Create message includes three fields, a user phone number field (“GROUP_NAME”) to identify the entity that controls the registration, a group administrator defined name to identify the port (“PORT_NAME”), and an optional password (“PASSWORD”) so that only the administrator can make access and registration available for the group, and a group phone number registration (“ADMIN_PHONE_NUMBER”) to provide the associated number. Table 8a shows the general lay out of a message data field for a Port_Create message. Table 8b shows one example of a Port_Create message according to this embodiment.

Similarly, Tables 8c/8d, 8e/8f, and 8g/8h, show the fields for other message types and corresponding examples according to this embodiment. Tables 8c/8d show the Port_Attribute_register message, which is sent by a group member who wishes to register attributes. The port name and password are provided to the new member by the administrator through some means (orally, written, etc.). Tables 8e/8f show the Group_Attribute_resolve message, which is sent by a group member who wishes to make a phone call based on an attribute. As above, the port name and password are provided to the member by the administrator through some means (orally, written, etc.). Similarly, Tables 8g/8h show the Port_empty message, which is sent by a group administrator to free up a port. The password for the port is changed so that the port may be re-used later by some other new member. For example, this can happen when the administrator provides port name and password to the new member.

TABLE 8a

| | | |
|---|---|---|
| PORT | CREATE | DATA_LENGTH |

GROUP_NAME=VALUE; PORT_NAME=VALUE;
PASSWORD=VALUE; ADMIN_PHONE_NUMBER=VALUE;

TABLE 8b

| | | |
|---|---|---|
| | | Computed length of remaining |
| PORT | CREATE | data |

GROUP_NAME=ShortEats; PORT_NAME=temp;
PASSWORD=2345; ADMIN_PHONE_NUMBER=6132226789;

TABLE 8c

| | | |
|---|---|---|
| PORT | ATTRIBUTE_REGISTER | DATA_LENGTH |

GROUP_NAME=VALUE; PORT_NAME=VALUE;
PASSWORD=VALUE; MEMBER_PHONE_NUMBER=VALUE;
[Semicolon separated list of attribute/values pairs]

TABLE 8d

| | | |
|---|---|---|
| PORT | ATTRIBUTE_REGISTER | Computed length of remaining data |

GROUP_NAME=ShortEats; PORT_NAME=temp;
PASSWORD=2345; OCCUPATION=real estate agent; HOBBIES=skiing;

TABLE 8e

| | | |
|---|---|---|
| PORT | ATTRIBUTE_RESOLVE | DATA_LENGTH |

GROUP_NAME=VALUE; PORT_NAME=VALUE;
PASSWORD=VALUE; ATTRIBUTE;

TABLE 8f

| | | |
|---|---|---|
| PORT | ATTRIBUTE_RESOLVE | Computed length of remaining data |

GROUP_NAME=ShortEats; PORT_NAME=temp1;
PASSWORD=1122; OCCUPATION=real estate agent;

TABLE 8g

| | | |
|---|---|---|
| PORT | EMPTY | Computed length of remaining data |

GROUP_NAME=VALUE; PORT_NAME=VALUE;
PASSWORD=VALUE; NEW_PASSWORD=VALUE;
ADMIN_PHONE_NUMBER=VALUE;

TABLE 8h

| | | |
|---|---|---|
| PORT | EMPTY | Computed length of remaining data |

GROUP_NAME=ShortEats; PORT_NAME=temp; PASSWORD=2345;
NEW_PASSWORD=1122; ADMIN_PHONE_NUMBER=6132226789

The messages can be handled by the RC 106 and STP pair 112 to set-up a group and store and retrieve group related information according to the present embodiment. The group information is also stored in database 108, which maintains the attribute—phone number correlation information. Database 108 stores this information in a set of group tables, including a Group definition table, a Group_ports table, and a Port_attribute table which is equivalent to the attribute table for non-group embodiments. The SCP Pair 110 and the RC 106 share this same database 108. The group information is stored according to the layout shown in tables 9a-9f.

Table 9a shows the layout for the Group_definition table, which includes the GROUP_NAME field, the GROUP_PHONE_NUMBER field (the virtual number associated with the service for a particular entity), and the GROUP_ADMIN_PHONE_NUMBER field. Table 9b shows one example of a Group_definition table entry:

Similarly, Tables 9c/9d and 9e/9f show the fields for other database tables and their corresponding sample entries according to this embodiment. Tables 9c/9d show the Group_ports table, which stores port information. The information in the PORT_CREATE message is used to populate this table. Similarly, Tables 9e/9f show the Ports_attributes table, which stores the group member user information sent when a group member user sends a PORT_ATTRIBUTE_REGISTRATION message.

TABLE 9a

| | | |
|---|---|---|
| GROUP_NAME | GROUP_PHONE_NUMBER | GROUP_ADMIN_PHONE_NUMBER |

TABLE 9b

| GROUP_NAME | GROUP_PHONE_NUMBER | GROUP_ADMIN_PHONE_NUMBER |
|---|---|---|
| ShortEats | 600666777 | 6132226789 |

TABLE 9c

| | | |
|---|---|---|
| GROUP_PHONE_NUMBER | PORT_NAME | PASSWORD |

TABLE 9d

| GROUP_PHONE_NUMBER | PORT_NAME | PASSWORD |
|---|---|---|
| 6006667777 | Temp | 2345 |

TABLE 9e

| | | | | |
|---|---|---|---|---|
| GROUP_PHONE_{—} | PORT_NAME | MEMBER_PHONE_{—} | ATTRIBUTE_NAME | VALUE |
| NUMBER | | NUMBER | | |

TABLE 9f

| GROUP_PHONE_{—} | | MEMBER_PHONE_{—} | | |
|---|---|---|---|---|
| NUMBER | PORT_NAME | NUMBER | ATTRIBUTE_NAME | VALUE |
| 6006667777 | Temp | 7454565463 | OCCUPATION | Real |
| | | | | estate |
| | | | | agent |
| 6006667777 | Temp | 7454565463 | HOBBIES | skiing |

### System Operation

For description purposes, a set of sample phone numbers are used to describe the operation of the system according to one embodiment of the present invention. As a general matter, the area code “600” used in connection with this description is intended to represent a conventional virtual number prefix, e.g., 800, 877, or the like. Elements of the system 400 are associated with phone numbers as follows:

| Group Name | ShortEats |
|---|---|
| Group administrator phone number | 613-222-6789 |
| Group phone number | 600-666-7777 |
| Registration center number | 600-444-6666 |
| Tom's phone number | 745-456-5463 |

Table 10 describes one embodiment of system 400 as shown in FIG. 4. For illustration purposes, corresponding examples to each of the steps relate to a sample transaction. In this example, a hypothetical restaurant “ShortEats” decides to avail of the “spot grouping” service. The management of the restaurant identifies James to be the group administrator.

TABLE 10

| Step | Description | Example |
|---|---|---|
| 411 | Group creation: | A group called “ShortEats” is created with |
| | A group is created by assigning a | James being selected as the group |
| | virtual phone number to represent the | administrator. |
| | group and designating a phone number | The following information is provided to the |
| | as the group administrator 402 phone | Registration center: |
| | number. | Group name: ShortEats |
| | This information is provided to the | Group administrator phone number: |
| | Registration center 106. | 6132226789 |
| | | Group phone number: 6006667777 |
| 412 | Group creation information is stored in | Registration center stores the information in |
| | a database 108. The database 108 is | the group_definition table. |
| | accessible to the SCP 110. | |
| 413 | Port creation: | James sends a Port_create message to the |
| | Group administrator sends “port | registration phone number (600-444-6666). |
| | creation” message to the registration | The message parameters are: |
| | phone number. | GROUP_NAME=ShortEats |
| | | PORT_NAME=temp |
| | | PASSWORD=2345 |
| | | ADMIN_PHONE_NUMBER=6132226789; |
| 414 | Switch 104 routes call to Registration | |
| | center 106. | |
| 415 | Registration center 106 validates call is | At the registration center the call originator is |
| | from group administrator and then | validated using the |
| | stores port information in database | ADMIN_PHONE_NUMBER parameter and |
| | 108. | port name and password are recorded in the |
| | | database. |
| | | The Group_ports table is populated as |
| | | follows: |
| | | GROUP_PHONE_NUMBER=6006667777, |
| | | PORT_NAME=temp, |
| | | PASSWORD=2345 |
| 416 | Port information is provided to new | Tom walks into the restaurant and is provided |
| | member 102b. | with port name and password. |
| | (By some means not defined by this | |
| | system--e.g. orally) | |
| 417 | Member 102b registers attributes | Tom registers his profession attribute in the |
| | through port. | group by sending a Port_Attribute_register |
| | | message to the registration phone number. |
| | | (600-444-6666) |
| | | The message parameters are: |
| | | GROUP_NAME=ShortEats; |
| | | PORT_NAME=temp; |
| | | PASSWORD=2345; |
| | | MEMBER_PHONE_NUMBER=7454565463 |
| | | OCCUPATION=real estate agent |
| | | HOBBIES=skiing |
| 418 | Switch 104 routes call to Registration | |
| | center 106. | |
| 419 | Registration center 106 stores details | At the registration center the group, port, |
| | in a database 108. | password is validated and then Tom's |
| | | attributes are recorded in the SCP database. |
| | | (The Port_attributes table is populated with |
| | | attribute and phone number information.) |
| 420 | Port creation for caller 102a: | Anita enters the restaurant. Since the |
| | Group administrator sends | restaurant provides all customers an |
| | “port_create” message to the | opportunity to communicate using their |
| | registration phone number. | group, James needs to create a port for her. |
| | | James sends a Port_create message to the |
| | | registration phone number (600-444-6666). |
| | | The message parameters are: |
| | | GROUP_NAME=ShortEats; |
| | | PORT_NAME=temp1; |
| | | PASSWORD=1122 |
| | | ADMIN_PHONE_NUMBER=6132226789; |
| 421 | Switch 104 routes call to Registration | |
| | center 106. | |
| 422 | Registration center 106 stores details | At the registration center the call originator is |
| | in a database 108. | validated using the |
| | | ADMIN_PHONE_NUMBER parameter and |
| | | port name and password are recorded in the |
| | | database. |
| | | The Group_ports table is populated as |
| | | follows: |
| | | GROUP_PHONE_NUMBER=6006667777, |
| | | PORT_NAME=temp1, |
| | | PASSWORD=1122 |
| 423 | Port information is provided to new | Anita is provided a port name and password. |
| | member 102a. | |
| 424 | Attribute call | She decides to try and locate a real estate |
| | Caller 102a sends a | agent in the restaurant. She sends a |
| | Group_attribute_resolve message | Group_attribute_resolve message to the group |
| | specifying attributes and desired values | phone number (6006667777). |
| | to a designated and virtual phone | The message parameters are: |
| | number. | GROUP_NAME=ShortEats; |
| | | PORT_NAME=temp1; PASSWORD=1122; |
| | | OCCUPATION=real estate agent; |
| 425 | The switch 104 realizes it cannot | Switch S realizes it cannot complete a 600 |
| | complete the call and sends a query to | series number and so sends a query to STP |
| | STP 112. | with attribute information specified in the call |
| | | and the virtual phone number (6006667777). |
| 426 | STP 112 sends the query to SCP 110. | |
| 427 | SCP 110 uses the passed information | SCP uses the passed attribute information to |
| | to query database 108 for stored | look for a record that matches. By looking |
| | records and retrieves associated phone | for records belonging to the specified group |
| | number. The phone number is then | phone number (6006667777), the search is |
| | passed back in a response to STP 112. | restricted to members within the group. |
| | | Further the port name, password information |
| | | in the message is validated against the |
| | | database to validated against the database to |
| | | validate the sender. It retrieves Tom's phone |
| | | number since his attribute matches the one |
| | | specified in the query. |
| | | (ATTRIBUTE_NAME=OCCUPATION, |
| | | VALUE=real estate agent) |
| | | SCP returns Tom's number to STP. |
| 428 | STP 112 sends response back to switch | |
| | 104. | |
| 429 | Switch 104 completes call with other | Switch S knows Tom's phone number is |
| | phone. | handled by it and so completes the connection |
| | | with Tom's phone. |

Unrestricted Registration

As mentioned above, another type of group enabled system includes the unrestricted registration groups. According to this embodiment, it is possible to create groups with no administration control over registration. This may be useful in some cases, where a spontaneous group formation may occur. For example, people caught in a traffic jam can form a group and coordinate among themselves. Someone asks for group creation by the mobile network and then others joining the group—the mobile network facilitates the group creation. A suitable convention such as using <location of traffic jam>_traffic_jam can be used so that people know the group name.

### Illustrative Embodiment Based on Visual Identification

In many situations we identify the person we need to speak with through visual sight: i.e. with our eyes. However, there is no way to use that identification as the basis of communicating with them electronically. Accordingly, another aspect of the present invention includes an embodiment of a system that enables communications based on visual identification.

According to this embodiment, a communication group is created as described above. For visual identification, attributes that can be identified visually are used (e.g., hair color, height, other physical body features, photograph, and the like). A Caller can specify attribute(s) that will be matched with the attributes registered in the group. If more than one match occurs caller can use other registered attributes to narrow down choice to intended recipient. Other algorithms like round-robin can also be used to reach the intended recipient. (round-robin calling would mean calling each of the people with matching registrations one by one till the correct person is reached).

We can also create an attribute that will be unique in a group. One way of creating such an attribute is to provide an identification badge to each person in the group. The badge and the identification name printed on it are available in the visible domain. The identification name on the badge can be used as a unique attribute in the electronic communication domain. When a person is identified visually, the identification name on the badge can be used to make an attribute call to the person.

Illustrative Scenario using Mobile Phones

In this system an identification badge is created to provide the link between the visual and electronic communication domains. Since the group administrator creates the badges, the badges can be maintained unique within the group. The identification badge is meant to establish identity only for the purpose of communication within the group. Thus it may have no relationship to the real identity of the person. As long as the person remains a member of the group she retains the identity and the ability to communicate. This temporary identity can be discarded at any time and there is no loss of privacy.

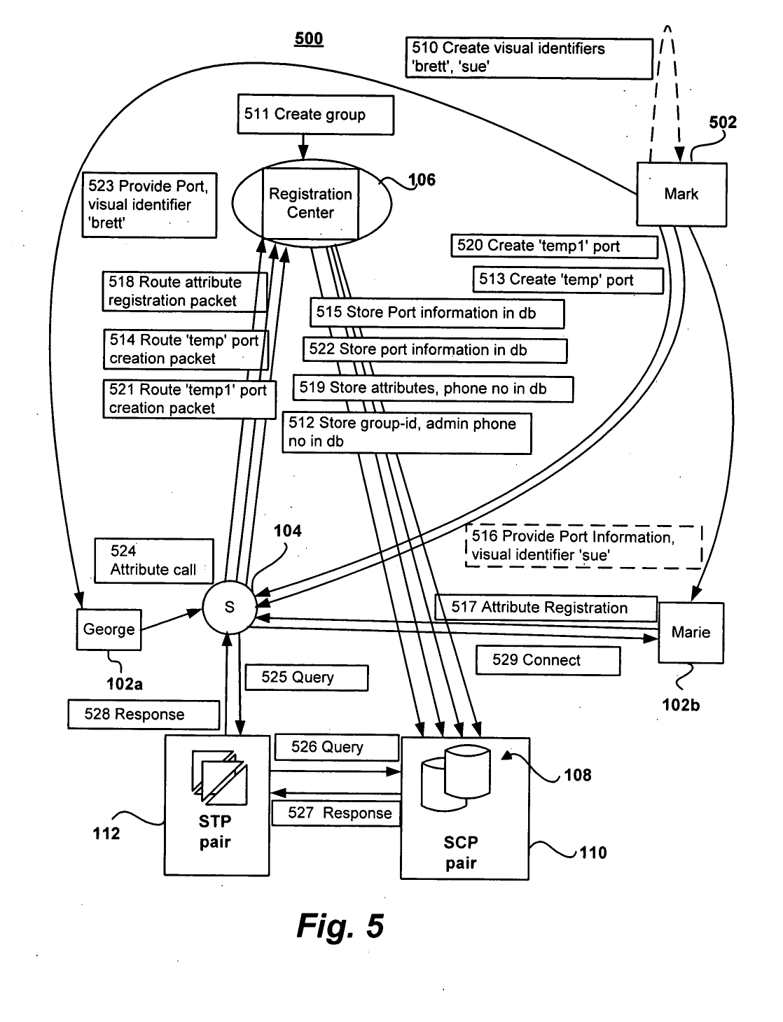

Now referring to FIG. 5, a visual identification call system 500 according to this embodiment is shown. For description purposes, a sample scenario will be referred to in which George calls Maria. The system 500 includes network components as described with respect to FIGS. 1, 2, and 4. Like elements are reference with like numbers.

The message types, layouts, and corresponding database tables are similar to those described with respect to the Group enabled embodiments.

### System Operation

For description purposes, a set of sample phone numbers are used to describe the operation of the system according to one embodiment of the present invention. As a general matter, the area code “600” used in connection with this description is intended to represent a conventional virtual number prefix, e.g., 800, 877, or the like. Elements of the system 500 are associated with phone numbers as follows:

| Group Name | Energy_Seminar |
|---|---|
| Group administrator phone number | 625-789-1234 |
| Group phone number | 600-565-6556 |
| Registration center number | 600-444-6666 |
| Maria's phone number | 713-234-8888 |

Table 11 describes one embodiment of system 500 as shown in FIG. 5. For illustration purposes, corresponding examples to each of the steps relate to a sample transaction. In this example, a hypothetical seminar on Energy conservation uses a visual identification based electronic communication system 500. “Mark” is designated the group administrator 502.

TABLE 11

| Step | Description | Example |
|---|---|---|
| 510 | Visual identification creation: | Mark creates identification badges for the |
| | Group management 502 creates | participants; among these identities is “brett”, |
| | identification badges for use by members | “sue”. These identifiers are temporary identities |
| | of the group (102). | and are used for communication within the |
| | | group. |
| 511 | Group creation: | A group called “Energy_Seminar” is created |
| | A group is created by assigning a virtual | with Mark being selected as the group |
| | phone number to represent the group and | administrator. |
| | designating a phone number as the group | The following information is provided to the |
| | administrator 502 phone number. | Registration center: |
| | This information is provided to the | Group name: Energy_Seminar |
| | Registration center 106. | Group administrator phone number: 6257891234 |
| | | Group phone number: 6005656556 |
| 512 | Group creation information is stored in a | At the Registration center the information is |
| | database 108. The database is accessible to | stored in the group_definition table. |
| | the SCP 110. | |
| 513 | Port creation: | Mark sends a Port_create message to the |
| | Group administrator 502 sends | registration phone number (600-444-6666). |
| | “port_create” message to the registration | The message parameters are: |
| | phone number. | GROUP_NAME=Energy_Seminar; |
| | | PORT_NAME=temp; |
| | | PASSWORD=2345 |
| | | ADMIN_PHONE_NUMBER=6257891234; |
| 514 | Switch 104 routes call to Registration | |
| | center 106. | |
| 515 | Registration center 106 validates call is | At the registration center the call originator is |
| | from group administrator and then stores | validated using the ADMIN_PHONE_NUMBER |
| | port information in database 108. | parameter and port name and password are |
| | | recorded in the database. |
| | | The Group_ports table is populated as follows: |
| | | GROUP_PHONE_NUMBER=6005656556, |
| | | PORT_NAME=temp, |
| | | PASSWORD=2345 |
| 516 | Port information is provided to new | Maria enters the seminar hall and is provided |
| | member 102b. | with port name and password. In addition her |
| | (By some means not defined by this | visual identifier “sue” is provided to her. |
| | system—e.g. orally) | |
| 517 | Member 102b registers attributes through | Maria registers her visual identification attribute |
| | port. | in the group by sending a Port_Attribute_register |
| | | message to the registration phone number. (600- |
| | | 444-6666) |
| | | The message parameters are: |
| | | GROUP-NAME=Energy_Seminar; |
| | | PORT_NAME=temp; |
| | | PASSW0RD=2345; |
| | | MEMBER_PHONE_NUMBER=7132348888; |
| | | VISUAL_IDENTIFICATION=sue; |
| | | She then displays her visual identifier by wearing |
| | | her identification badge. |
| 518 | Switch 104 routes call to Registration | |
| | center 106. | |
| 519 | Registration center 106 stores details in a | At the registration center the group, port, |
| | database 108. | password is validated and then Maria's attributes |
| | | are recorded in the SCP database. The |
| | | Port_attributes table is populated with attribute |
| | | and phone number information. |
| 520 | Port creation for caller 102a: | George enters the seminar hall. Mark needs to |
| | Group administrator 502 sends | create a port for him. |
| | “port_creation” message to the registration | Mark sends a Port_create message to the |
| | phone number. | registration phone number (600-444-6666). The |
| | | message parameters are: |
| | | GROUP_NAME=Energy_Seminar; |
| | | PORT_NAME=temp1; |
| | | PASSWORD=1122 |
| | | ADMIN_PHONE_NUMBER=6257891234; |
| 521 | Switch 103 routes call to Registration | |
| | center 106. | |
| 522 | Registration center 106 stores details in a | At the registration center the call originator is |
| | database 108. | validated using the ADMIN_PHONE_NUMBER |
| | | parameter and port name and password are |
| | | recorded in the database. |
| | | The Group_ports table is populated as follows: |
| | | GROUP_PHONE_NUMBER=6005656556, |
| | | PORT_NAME=temp1, |
| | | PASSWORD=1122 |
| 523 | Port info provided to caller 102a. | George is provided a port name and password. |
| | | He is also provided his visual identifier “brett”. |
| 524 | Attribute call | George decides that he needs some information |
| | Caller 102a sends a data packet specifying | from the person he can visually identify a “sue”. |
| | attributes and desired values to a | He sends a Group_attribute_resolve message to |
| | designated and virtual phone number. | the group phone number (6005656556). |
| | | The message parameters are: |
| | | GROUP_NAME=Energy_Seminar; |
| | | PORT_NAME=temp1; PASSWORD=1122; |
| | | VISUAL_IDENTIFIER=sue; |
| 525 | The switch 104 realizes it cannot complete | Switch S realizes it cannot complete a 600 series |
| | the call and sends a query to STP 112. | number and so sends a query to STP with |
| | | attribute information specified in the call and the |
| | | virtual phone number (6005656556). |
| 526 | STP 112 sends the query to SCP 110. | |
| 527 | SCP 110 uses the passed information to | SCP uses the passed attribute information to look |
| | query database 108 for stored records and | for a record that matches. By looking for records |
| | retrieves associated phone number. The | belonging to the specified group phone number |
| | phone number is then passed back in a | (6005656556), the search is restricted to |
| | response to STP 112. | members within the group. Further the port |
| | | name, password information in the message is |
| | | validated against the database to validate the |
| | | sender. It retrieves Maria's phone number since |
| | | her attribute matches the one specified in the |
| | | query. |
| | | (ATTRIBUTE_NAME=VISUAL_IDENTIFIER, |
| | | VALUE=sue) |
| | | SCP returns Maria's number to STP. |
| 528 | STP 112 sends response back to switch | |
| | 104. | |
| 529 | Switch 104 now completes call with other | Switch S knows Maria's phone number is |
| | phone. | handled by it and so completes the connection |
| | | with Maria's phone. |

The implementation of these techniques as well as similar adaptations falls within the scope of this invention.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

1. An attribute based communication system for establishing communication channels between an originating user and a target user, the system comprising:
an access switch associated with an originating user communication unit, the access switch configured to receive a communication request message from the originating user communication unit and determining a network identifier of a target communication unit based on the communication request message, the communication request message including an identification attribute of the target user;
a registration database communicatively coupled with the switch via message routing equipment, the registration database configured to store a target user record indicating a correlation between the network identifier of the target user communication unit and one or more associated identification attributes of the target user; and
a registration center communicatively coupled with the access switch and the registration database and configured to receive record editing messages from the target user to modify the associated identification attributes in the target user record.

2. The system of claim 1, wherein the originating and target user communication units are wireless telephones.

3. The system of claim 1, wherein the messages are messaging service messages.

4. The system of claim 3, wherein the messaging service is a Short Messaging Service.

5. The system of claim 3, wherein the messaging service is a Multimedia Messaging Service.

6. The system of claim 3, wherein the communication request message includes a virtual phone number.

7. The system of claim 1, further comprising a signal connection point communicatively coupled to the access switch and configured to provide the network identifier of the target communication unit to the switch in response to a switch target network identifier determination request.

8. The system of claim 7, wherein the signal connection point is further communicatively coupled to the registration database for retrieving the network identifier of the target communication unit based on the one or more associated identification attributes of the target user.

9. The system of claim 1, wherein the message routing equipment is at least part of a wireless communications network.

10. The system of claim 9, wherein the wireless communication network operates according to at least one protocol associated with one of the group consisting of GSM, DCS, PCS, PCD, GPRS, Bluetooth, and IrDA.

11. A computer based method for establishing communication channels between an originating user and a target user, the method comprising:
receiving a record registration message, the record registration message including one or more target user attributes and a network identifier for a target user communication unit;
storing in a target user record the one or more target user attributes and the network identifier for the target user communication unit;
receiving a communication request message from an originating user, the communication request message including an attribute of the target user;
determining the network identifier of the target user communication unit by relating the communication request message with the target user record to identify an attribute match;
establishing a communication channel between the originating user and the target user at least in part by routing communications from the originating user to the network identifier of the target user communication unit.

12. The method of claim 11, wherein the attributes include an attribute name and an attribute value.

13. The method of claim 11, wherein the attributes include one of the group consisting of an occupation, a visually displayed alphanumeric string, a relative location, a set of GPS coordinates, and a visible personal characteristic.

14. The method of claim 11, wherein establishing the communication channel between the originating user and the target user further comprises concealing the network identifier of the target user communication unit from the originating user.

15. The method of claim 11, wherein the communication units are telephones and the network identifiers are telephone numbers.

16. The method of 15, wherein the communication units are wireless telephones and the messages are short messaging system messages.

17. The method of claim 12, wherein the attribute further includes a time period.

18. The method of claim 17, wherein the record registration message includes plurality of target user attributes, and further wherein the time period in the in each of the plurality of target user attributes indicates which attribute values are available for relating the communication request message with the target user record during a particular time.

19. The method of claim 11, wherein the communications from the originating user include voice data associated with a telephone call.

20. A system for establishing communication channels between an originating user and a target user, the system comprising:
means for receiving a record registration message, the record registration message including a target user attribute and a network identifier for a target user communication unit;
means for storing in a target user record the target user attribute and the network identifier for the target user communication unit;
means for receiving a communication request message from an originating user, the communication request message including an attribute of the target user;
means for determining the network identifier of the target user communication unit by relating the communication request message with the target user record to identify an attribute match;
means for establishing a communication channel between the originating user and the target user at least in part by routing communications from the originating user to the network identifier of the target user communication unit.

21. A computer based method for establishing an anonymous communication link between an originating user and a target user, the method comprising:
receiving a bridge create message from the target user, the bridge create message including a bridge name, a bridge password, and a network identifier for a target user communication unit;
storing in a bridge table the bridge name, the bridge password, and the network identifier for the target user communication unit;
receiving a bridge add message from an originating user, the bridge add message including the bridge name, the bridge password, and a network identifier of a communication unit of the originating user;
receiving a bridge connect message from one of the originating user or the target user, the bridge connect message including the bridge name, and the bridge password;
determining the network identifiers of the target user communication unit and the originating user communication unit by relating the bridge add message with the bridge table; and
establishing a communication link between the originating user and the target user by routing communications between the network identifiers of the originating user communication unit and the target user communication unit.

22. The method of claim 21, wherein the communication units are telephones and the network identifiers are telephone numbers.

23. The method of 22, wherein the communication units are wireless telephones and the messages are short messaging system messages.

24. The method of claim 21, wherein the bridge create message further comprises a bridge time period indicating at least a bridge termination time upon which the bridge table is cleared of information relating to the bridge.

25. The method of claim 21, wherein the originating user is provided the bridge name and bridge password in an electronic mail message.

26. A system for establishing an anonymous communication link between an originating user and a target user, the system comprising:
means for receiving a bridge create message from the target user, the bridge create message including a bridge name, a bridge password, and a network identifier for a target user communication unit;
means for storing in a bridge table the bridge name, the bridge password, and the network identifier for the target user communication unit;
means for receiving a bridge add message from an originating user, the bridge add message including the bridge name, the bridge password, and a network identifier of a communication unit of the originating user;
means for receiving a bridge connect message from one of the originating user or the target user, the bridge connect message including the bridge name, and the bridge password;
means for determining the network identifiers of the target user communication unit and the originating user communication unit by relating the bridge add message with the bridge table; and
means for establishing a communication link between the originating user and the target user by routing communications between the network identifiers of the originating user communication unit and the target user communication unit.

27. A computer based method for establishing an attribute based communication connection between an originating user and a target user within a dynamic group network, the method comprising:
receiving a group create message from a group provider, the group create message including a group name for storage in a group record;
receiving a group member registration message, the group member registration message including the group name, a target user attribute, and a target network identifier for a target user communication unit;
storing in a first port record associated with the group record, the target user attribute, and the target network identifier;
receiving a group attribute resolve message from an originating user, the group attribute resolve message including the group name, and a target user attribute;
determining the network identifier of the target user communication unit by relating the group attribute resolve message with the group record; and
establishing a communication link between the originating user and the target user at least in part by routing communications from the originating user to the network identifier of the target user communication unit.

28. The method of claim 27, wherein the communication units are wireless telephones.

29. The method of claim 27, wherein the attribute includes and attribute name and an attribute value.

30. The method of claim 27, wherein the network identifiers are telephone numbers associated with a telephone network.

31. The method of claim 28, wherein the messages are short messaging system messages.

32. The method of claim 27, wherein the group create message further includes a group network identifier, and an administrator network identifier for a communication unit associated with a group administrator, and wherein the storing in a group record further includes storing the group network identifier, and the administrator network identifier, the method further comprising:
receiving a first port add message from the group administrator, the first port add message including the group name, a first port name, a first port password, and the administrator network identifier; and
receiving a second port add message from the group administrator, the second port add message including the group name, a second port name, a second port password, and the administrator network identifier.

33. The method of claim 32, wherein the group member registration message further includes the first port name and the first port password, and further wherein the group attribute resolve message further includes the second port name and the second port password.

34. The method of claim 32, wherein the group create message further includes a group administrator password for inclusion in the port add messages.

35. The method of claim 33, wherein the group provider is a commercial establishment.

36. The method of claim 35, wherein the originating user is provided the second port name and second port password and the target user is provided the first port name and the first port password in the commercial establishment.

37. The method of claim 32, wherein the target user attribute is a visually displayed identifier.

38. A system for establishing an attribute based communication connection between an originating user and a target user within a dynamic group network, the system comprising:
means for receiving a group create message from a group provider, the group create message including a group name for storage in a group record;
means for receiving a group member registration message, the group member registration message including the group name, a target user attribute, and a target network identifier for a target user communication unit;
means for storing in a first port record associated with the group record, the target user attribute, and the target network identifier;
means for receiving a group attribute resolve message from an originating user, the group attribute resolve message including the group name, and a target user attribute;
means for determining the network identifier of the target user communication unit by relating the group attribute resolve message with the group record; and
means for establishing a communication link between the originating user and the target user at least in part by routing communications from the originating user to the network identifier of the target user communication unit.

39. A computer readable medium comprising a computer program that when executed in a computer processor implements the steps of:
receiving a record registration message, the record registration message including one or more target user attributes and a network identifier for a target user communication unit;
storing in a target user record the one or more target user attributes and the network identifier for the target user communication unit;
receiving a communication request message from an originating user, the communication request message including an attribute of the target user;
determining the network identifier of the target user communication unit by relating the communication request message with the target user record to identify an attribute match;
establishing a communication channel between the originating user and the target user at least in part by routing communications from the originating user to the network identifier of the target user communication unit.

40. A computer readable medium comprising a computer program that when executed in a computer processor implements the steps of:
receiving a bridge create message from the target user, the bridge create message including a bridge name, a bridge password, and a network identifier for a target user communication unit;
storing in a bridge table the bridge name, the bridge password, and the network identifier for the target user communication unit;
receiving a bridge add message from an originating user, the bridge add message including the bridge name, the bridge password, and a network identifier of a communication unit of the originating user;
receiving a bridge connect message from one of the originating user or the target user, the bridge connect message including the bridge name, and the bridge password;
determining the network identifiers of the target user communication unit and the originating user communication unit by relating the bridge add message with the bridge table; and
establishing a communication link between the originating user and the target user by routing communications between the network identifiers of the originating user communication unit and the target user communication unit.

41. A computer readable medium comprising a computer program that when executed in a computer processor implements the steps of:
receiving a group create message from a group provider, the group create message including a group name for storage in a group record;
receiving a group member registration message, the group member registration message including the group name, a target user attribute, and a target network identifier for a target user communication unit;
storing in a first port record associated with the group record, the target user attribute, and the target network identifier;
receiving a group attribute resolve message from an originating user, the group attribute resolve message including the group name, and a target user attribute;
determining the network identifier of the target user communication unit by relating the group attribute resolve message with the group record; and
establishing a communication link between the originating user and the target user at least in part by routing communications from the originating user to the network identifier of the target user communication unit.

42. The computer readable medium of claim 41, wherein the group create message further includes a group network identifier, and an administrator network identifier for a communication unit associated with a group administrator, and wherein the storing in a group record further includes storing the group network identifier, and the administrator network identifier, and wherein the computer program, when executed in a computer processor, further implements the steps of:
receiving a first port add message from the group administrator, the first port add message including the group name, a first port name, a first port password, and the administrator network identifier; and
receiving a second port add message from the group administrator, the second port add message including the group name, a second port name, a second port password, and the administrator network identifier.
